(19) United States
(12) Patent Application Publication
(10) Pub. No.: US 2012/0258854 A1
(43) Pub. Date: Oct. 11, 2012

(54) METHOD FOR TREATING A SUPPORTED CATALYST

(76) Inventors: Tetsuo Kawamura, Aichi (JP); Minhua Shao, Manchester, CT (US); Lesia V. Protsailo, Bolton, CT (US); Chuan-jian Zhong, Endwell, NY (US); Bridgid Wanjala, Johnson City, NY (US); Jin Luo, Vestal, NY (US); Peter N. Njoki, Binghamton, NY (US); Rameshwori Loukrakpam, Binghamton, NY (US)

(21) Appl. No.: 13/516,932

(22) PCT Filed: Dec. 17, 2009
(86) PCT No.: PCT/US09/68382

§ 371 Date: Jun. 18, 2012

(51) Int. Cl. B01J 23/42; B01J 37/08; B01J 21/18; B01J 27/22; B82Y 30/00

(52) U.S. Cl. 502/177; 502/174; 502/185; 502/184; 977/742; 977/773

(57) ABSTRACT

A method for treating a supported catalyst includes establishing shell-removal conditions for a supported catalyst that includes nanoparticles of a catalyst material on a carbon support. The nanoparticles each include a platinum alloy core capped in an organic shell. The shell-removal conditions include an elevated temperature and an inert gas atmosphere that is substantially free of oxygen. The organic shell is then removed from the platinum alloy core in the shell-removal conditions.

### RELATED APPLICATION

This application claims priority to PCT/US2009/068382, filed on Dec. 17, 2009.

### BACKGROUND OF THE INVENTION

This disclosure relates to stable, high activity platinum alloy catalysts for use in fuel cells or other catalyst applications.

Fuel cells are commonly used for generating electric current. For example, a single fuel cell typically includes an anode catalyst, a cathode catalyst, and an electrolyte between the anode and cathode catalysts, for generating an electric current in a known electrochemical reaction between a fuel and an oxidant.

One issue encountered with fuel cells is the operational efficiency of the catalysts. For example, electrochemical activity at the cathode catalyst is one parameter that controls the efficiency. An indication of the electrochemical activity is the rate of electrochemical reduction of the oxidant at the cathode catalyst. Platinum has been used for the cathode catalyst. However, platinum is expensive and has a high over-potential for the cathodic oxygen reduction reaction. Also, platinum is relatively unstable in the harsh environment of the fuel cell. For instance, elevated temperatures and potential cycling may cause degradation of the electrochemical activity of the platinum over time due to catalyst dissolution and particle migration.

Platinum has been alloyed with certain transition metals to increase the catalytic activity and provide greater stability. Even so, the catalytic activity and stability for a given alloy composition depends to a considerable degree on the technique used to fabricate the alloy. As an example, some techniques may produce relatively large catalyst particle sizes and poor dispersion of the alloying elements, which may yield poor electrochemical activity in a fuel cell environment, despite the alloy composition.

### SUMMARY OF THE INVENTION

An exemplary method for treating a supported catalyst includes establishing shell-removal conditions for a supported catalyst. The supported catalyst includes nanoparticles of a catalyst material on a carbon support. The nanoparticles each include a platinum alloy core capped in an organic shell. The shell-removal conditions include an elevated temperature and an inert gas atmosphere that is substantially free of oxygen. The organic shell is then removed from the platinum alloy core in the shell-removal conditions.

In some examples, the nanoparticles may be supported on a carbon black support and the organic shell may include at least one of oleylamine or oleic acid. The platinum alloy core may include platinum and at least one alloy metal selected from nickel, iron, cobalt, iridium, chromium, molybdenum, palladium, rhodium, gold, copper and vanadium. The shell-removal conditions may include an elevated temperature higher than 220° C. and an inert atmosphere that is substantially free of oxygen. After the organic shell is removed from the platinum alloy core, the platinum alloy core may be annealed at an annealing temperature of 400° C.-1200° C. in a reducing or inert atmosphere.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 illustrates an example of a supported catalyst having a nanoparticle that includes an organic shell.

FIG. 2 illustrates the supported catalyst after removing an organic shell from the nanoparticle.

FIG. 3 illustrates an example of a method for treating a supported catalyst.

FIG. 4 illustrates a graph of mass activity of platinum alloys annealed at different temperatures compared with a state-of-the-art Pt catalyst.

FIG. 5 illustrates a graph of mass activity versus potential cycling number for platinum alloy catalysts annealed at different temperatures.

### DETAILED DESCRIPTION OF THE PREFERRED EMBODIMENT

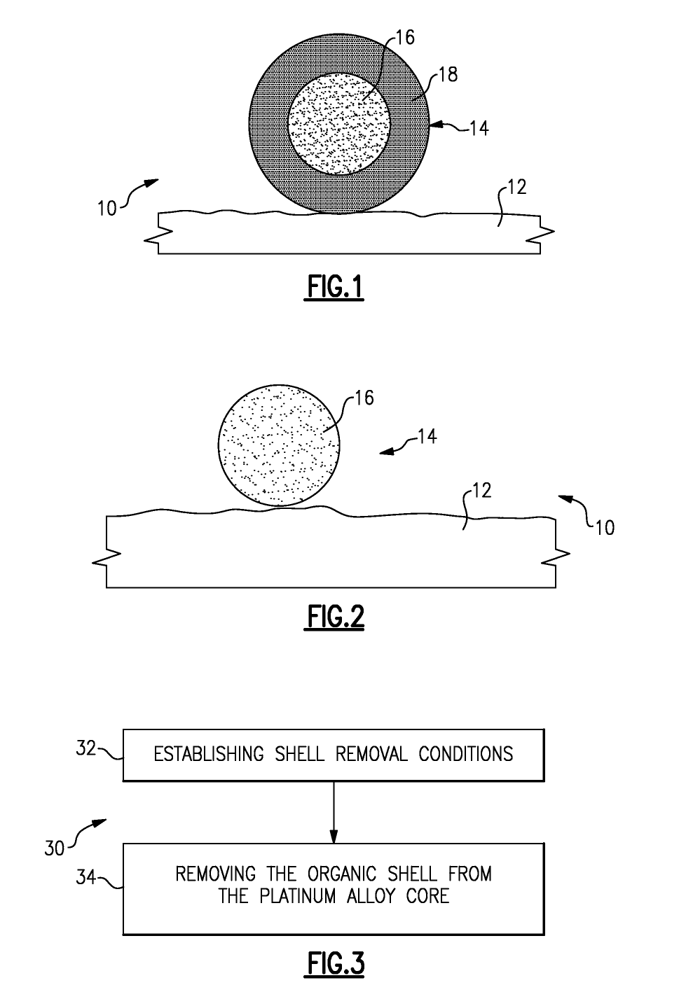

FIG. 1 illustrates selected portions of an example supported catalyst 10 that may be used in a fuel cell or other catalytic environment. In this example, the supported catalyst 10 is “in-process” and is in an intermediate form relative to the intended final supported catalyst. In this case, the supported catalyst 10 includes a carbon support 12 that supports a plurality of nanoparticles 14 (only one nanoparticle 14 is shown but is representative of a plurality). As an example, the nanoparticles 14 may have an average particle size determined on a nanoscopic scale. In some examples, the nanoscopic scale may be 1-100 nanometers. However, for many end uses, a desirable particle size may be less than 10 nanometers, or even under 3 nanometers.

Each of the nanoparticles 14 includes a platinum alloy core 16 capped in (i.e., surrounded by) an organic shell 18. The organic shell 18 is a product of the technique used to fabricate the nanoparticle 14. The supported catalyst 10 may be fabricated using known polyol processing techniques. As an example, the supported catalyst 10 may be fabricated using the techniques disclosed in U.S. Pat. Nos. 7,053,021 and 7,335,245, which utilize polyol processing techniques. However, this disclosure is not limited to the methods disclosed therein.

As is known, the polyol processing technique provides a platinum alloy core 16 surrounded by a capping material, the organic shell 18 in this case. In a few examples, the platinum alloy core 16 may include platinum in combination with one or more alloy metals. The alloy metal may be iron, nickel, cobalt, iridium, chromium, molybdenum, palladium, rhodium, gold, copper, vanadium, or combinations thereof. In some examples, the platinum alloy core 16 may include only the given elements, or the given elements and impurities or additions that do not materially affect the properties of the platinum alloy core 16.

In one example, the platinum alloy core 16 is a ternary or quaternary alloy that includes, respectively, three or four different metals. In a few specific examples, the platinum alloy core 16 may be Pt₂₀₋₆₀Ni₅₋₂₀CO₃₀₋₆₀ or Pt₂₀₋₆₀V₅₋₂₀CO₃₀₋₆₀, where the amounts of each element are atomic percent and add up to one-hundred. These compositions are well suited for end use in a fuel cell because of the high electrochemical activity and stability (resistance to dissolution and degradation).

The material of the organic shell 18 depends on the specific parameters selected for the fabrication technique. For instance, the organic shell 18 may be oleylamine, oleic acid, thiol, polyacrylic acid, trimethylaluminum, tetraoctylammonium bromide, sodium dodecyl sulfate, acetic acid, cetryltrimethylammonium chloride, or a combination thereof. In this case, the organic shell 18 is shown schematically but may include organic molecule ligands that are bonded to the platinum alloy core 16 in a known manner.

The nanoparticles 14 may be deposited onto the carbon support 12 in a known manner. The carbon support 12 may be carbon black particles. However, in other examples, the carbon support 12 may be another type of support suited for the particular intended end use such as unmodified carbon black, modified carbon black, carbon nanotubes, carbon nanowire, carbon fibers, graphitized carbon black, carbides, oxides, boron doped diamond, and combination thereof.

In this regard, the organic shells 18 of the nanoparticles 14 facilitate attaching the nanoparticles to the carbon support 12. Additionally, the organic shells 18 limit agglomeration of the platinum alloy cores 16, which might otherwise result in relatively large particles with limited chemical activity.

The organic shell 18 must be removed to expose the platinum alloy core 16 for catalytic activity. One premise of this disclosure is that prior methods used to remove organic shells may thermally decompose the carbon support 12 and lead to agglomeration of the platinum alloy cores 16. For instance, loss of the carbon support 12 through decomposition results in agglomeration of the nanoparticles 14. The larger agglomerate particles have lower electrochemical activity in a catalytic environment. However, as will be described in more detail, the exemplary methods disclosed herein for removing the organic shell 18 facilitate limiting decomposition of the carbon support 12 and agglomeration to provide a supported catalyst 10 having enhanced electrochemical activity and durability.

FIG. 2 illustrates the supported catalyst 10 and nanoparticle 14 after removing the organic shell 18. In this case, the platinum alloy core 16 is generally the same size as shown in FIG. 1 and has not combined with other platinum alloy cores 16 of other nanoparticles 14.

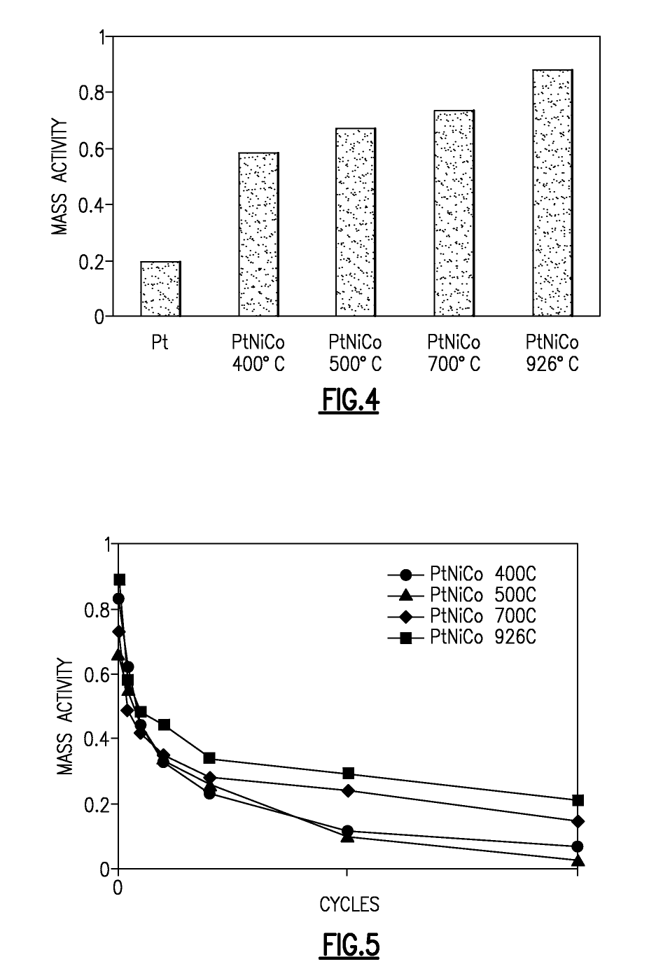

FIG. 3 illustrates an example method 30 for removing the organic shell 18 in a manner that facilitates limiting decomposition of the carbon support 12 and agglomeration of the platinum alloy cores 16. In this example, the method 30 includes a step 32 of establishing shell-removal conditions and a step 34 of removing the organic shell from the platinum alloy core 16. As an example, the establishing of the shell-removal conditions and the removing of the organic shell may be concurrent and/or overlapping in time and/or space. Generally, the shell-removal conditions may be maintained for a period of time in order to effect removal.

The shell removal conditions in step 32 may include an elevated temperature and an inert gas atmosphere that is substantially free of oxygen. That is, establishing the shell removal conditions may include providing the elevated temperature and the inert gas atmosphere conditions for treating the supported catalyst 10. In one example, step 32 may include heating a treatment chamber to the desired temperature and regulating the atmosphere in the chamber, such as by purging air out of the chamber with the inert gas. Known techniques may be used to set the temperature and atmosphere to desirable set points.

Subjecting the supported catalyst 10 to the shell-removal conditions removes the organic shell 18 from the platinum alloy core 16 in step 34. The elevated temperature decomposes the organic shell 18. The decomposed shell material may vaporize into the surrounding inert gas atmosphere. Depending on the shell composition, reactive intermediates may be released during decomposition. The inert gas atmosphere may be continually purged to reduce build-up of concentrations of the degradation products.

The supported catalyst 10 may reside in the shell-removal conditions for a predetermined amount of time, which may be easily experimentally determined using thermal gravimetric analysis to gauge when the shell material is completely removed. As an example, the time may be several hours or less.

The inert gas atmosphere is substantially free from oxygen and is thereby essentially unreactive with the carbon support 12. As an example, the atmosphere is controlled such that any oxygen present in the atmosphere is present at a level below which any significant oxidation of the carbon support is evident. Avoiding decomposition of the carbon support 12 maintains the surface area of the support and thereby avoids agglomeration of the platinum alloy cores 16. In contrast, if sufficient oxygen were present, the oxygen would react with the carbon support 12 in addition to reacting with the organic shell 18, cause agglomeration by reducing the surface area of the carbon support 12 and render the catalyst unsuitable for high activity applications such as fuel cells.

The inert gas used in the method 30 may be selected from any type of inert gas that is unreactive with the carbon support 12 or other type of support used. As an example, the inert gas may be nitrogen, argon, or a mixture thereof and is substantially free of oxygen. A small amount of oxygen may be present as an impurity. For instance, oxygen may be present up to a few volume percent; however, in other examples, the oxygen may be present in a concentration less than one part per million.

In some examples, the inert gas may be a mixture of nitrogen and/or argon with hydrogen or other trace amount of a reducing gas. For instance, the mixture may include up to about 10 vol % hydrogen. The hydrogen is a reducing agent and reacts with any oxygen in the inert gas mixture to consume the oxygen before the oxygen can react with the carbon support 12. Additionally, the hydrogen may reduce any non-reduced alloy metals of the platinum alloy core 16 that remain from the polyol processing technique.

The elevated temperature used for removing the organic shell in step 34 may be 220° C. or higher. In a further example, the temperature may be about 250° C.-290° C. And in a further example, the temperature may be about 270° C. Using a temperature in the given range is effective to remove the organic shell 18 without significantly affecting the carbon support 12. Furthermore, temperatures in the given range are too low to influence the alloying of the platinum alloy core 16. Additionally, heating the nanoparticles 14 at higher temperatures may cause some agglomeration. However, the relatively low temperature used to remove the organic shell 18 limits agglomeration. The temperature of 270° C. may provide a desirable balance between avoiding agglomeration and rapidly removing the organic shells 18.

In some examples, the nanoparticles 14 may be annealed after removing the organic shell 18 to homogenize (i.e., uniformly disperse) the platinum and alloy metal(s) used in the platinum alloy core 16. Relatively low annealing temperatures may not be effective to homogenize the alloy and relatively high annealing temperatures may cause severe agglomeration. In one example, the supported catalyst 10 is annealed at 400° C.-1200° C. for a predetermined amount of time after removing the organic shell 18. In a further example, the annealing temperature may be 700° C.-1000° C., and in a further example, the annealing temperature may be 800° C.-1000° C. Homogenizing the alloying facilitates improvement of the stability of the supported catalyst 10 and improves the activity. The annealing may be preceded by a pre-annealing step, which may include pre-annealing at a temperature in the lower end of the given annealing temperature range, such as 400° C.

FIGS. 4 and 5 illustrate examples of the influence of annealing temperature on the activity of the supported catalyst 10. In the graphs shown, the catalyst material of the supported catalyst 10 is platinum-nickel-cobalt. Pure platinum is also shown for comparison. In FIG. 4, the relative activity for annealing temperatures of 400° C., 500° C., 700° C. and 926° C. is shown. Higher annealing temperatures provide greater activity.

FIG. 5 illustrates the relative activity for platinum-nickel-cobalt catalysts processed at annealing temperatures of 400° C., 500° C., 700° C. and 926° C. versus potential cycles. In this case, higher annealing temperatures provide greater durability.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A method for treating a supported catalyst, comprising:
establishing shell-removal conditions for a supported catalyst that includes nanoparticles of a catalyst material on a carbon support, the nanoparticles each comprise a platinum alloy core capped in an organic shell, and the shell-removal conditions include an elevated temperature and an inert gas atmosphere that is substantially free of oxygen; and
removing the organic shell from the platinum alloy core in the shell-removal conditions.

2. The method as recited in claim 1, wherein the elevated temperature of the shell-removal conditions is 220° C.-600° C.

3. The method as recited in claim 1, wherein the elevated temperature of the shell-removal conditions is about 270° C.

4. The method as recited in claim 1, wherein the inert gas is selected from a group consisting of nitrogen, argon, and combinations thereof.

5. The method as recited in claim 1, wherein the removing of the organic shell includes thermal decomposition of the organic shell.

6. The method as recited in claim 1, wherein the inert gas atmosphere is a mixture of at least two different kinds of inert gases and hydrogen.

7. The method as recited in claim 6, wherein the mixture includes nitrogen, argon, and the hydrogen, and the hydrogen is present in an amount no greater than about 10 vol %.

8. The method as recited in claim 1, further comprising, after removing the organic shell, annealing the supported catalyst at an annealing temperature of 400° C.-1200° C.

9. The method as recited in claim 8, wherein the annealing temperature is 700° C.-1000° C.

10. The method as recited in claim 8, wherein the annealing temperature is 800° C.-1000° C.

11. The method as recited in claim 1, wherein the platinum alloy catalyst consists of platinum and at least one alloy metal selected from a group consisting of iron, nickel, cobalt, iridium, chromium, molybdenum, palladium, rhodium, gold, copper and vanadium.

12. The method as recited in claim 1, further comprising, prior to establishing the shell-removal conditions, forming the organic shells of the nanoparticles using a polyol process.

13. The method as recited in claim 1, wherein the support is carbon black, carbides, oxides, boron doped diamond, and combination thereof.

14. The method as recited in claim 1, wherein the support is unmodified carbon black, modified carbon black, graphitized carbon black, carbon nanotube, carbon nanowire, carbon fiber, and combination thereof.

15. The method as recited in claim 1, wherein the organic shell is selected from a group consisting of oleylamine, oleic acid, thiol, polyacrylic acid, trimethylaluminum, tetraoctylammonium bromide, sodium dodecyl sulfate, acetic acid, cetryltrimethylammonium chloride, and combinations thereof.

16. A method for treating a supported catalyst, comprising:
establishing shell-removal conditions for a supported catalyst that includes nanoparticles of a catalyst material on a carbon black support, the nanoparticles each comprise a platinum alloy core capped in an organic shell selected from a group consisting of oleylamine, oleic acid, and combinations thereof, the platinum alloy core includes platinum and at least one alloy metal selected from a group consisting of nickel, iron, cobalt, iridium, chromium, molybdenum, palladium, rhodium, gold, copper and vanadium, and the shell-removal conditions include an elevated temperature of higher than 220° C., and an inert gas atmosphere that is substantially free of oxygen;
removing the organic shell from the platinum alloy core in the shell-removal conditions; and
annealing the platinum alloy cores that remain after the removing of the organic shells at an annealing temperature of 400° C.-1200° C.

17. The method as recited in claim 14, further comprising, prior to establishing the shell-removal conditions, forming the organic shells of the nanoparticles using a polyol process.

18. A method for treating a supported catalyst, comprising:
establishing shell-removal conditions for a supported catalyst that includes nanoparticles of a catalyst material on a carbon support, the nanoparticles each comprise a platinum alloy core capped in an organic shell, and the shell-removal conditions include an elevated temperature and an atmosphere that is substantially free of oxygen and is substantially inert with respect to the carbon support;
removing the organic shell from the platinum alloy core in the shell-removal conditions; and
annealing the platinum alloy core, after shell-removal, at a temperature of at least 400° C.

19. A method for treating a supported catalyst, comprising:
establishing shell-removal conditions for a supported catalyst that includes nanoparticles of a catalyst material on a carbon black support, the nanoparticles each comprise a platinum alloy core capped in an organic shell selected from a group consisting of oleylamine, oleic acid, and combinations thereof, the platinum alloy core includes platinum and at least one alloy metal selected from a group consisting of nickel, iron, cobalt, iridium, chromium, molybdenum, palladium, rhodium, gold, copper and vanadium, and the shell-removal conditions include an elevated temperature of higher than 220° C., and an atmosphere that is substantially free of oxygen such that the atmosphere does not substantially decompose the carbon black support under the shell removal conditions;
removing the organic shell from the platinum alloy core in the shell-removal conditions; and
annealing the platinum alloy cores that remain after the removing of the organic shells at an annealing temperature of 400° C.-1200° C.
